(19) United States
(12) Patent Application Publication
(10) Pub. No.: US 2011/0083125 A1
(43) Pub. Date: Apr. 7, 2011

(54) PARALLELIZATION PROCESSING METHOD, SYSTEM AND PROGRAM

(75) Inventors: Hideaki Komatsu, Yamato (JP); Takeo Yoshizawa, Yamato (JP)

(73) Assignee: International Business Machines Corporation, Armonk, NY (US)

(21) Appl. No.: 12/898,851

(22) Filed: Oct. 6, 2010

(30) Foreign Application Priority Data
Oct. 6, 2009 (JP) 2009-232369

(51) Int. Cl. G06F 9/45

(52) U.S. Cl. 717/149

(57) ABSTRACT

A unified parallelization table is formed by describing a process, to be executed, with a plurality of control blocks and edges connecting the control blocks; selecting highly predictable edges from the edges; identifying strongly-connected clusters; creating a parallelization table, having the entries of the number of processors, the costs thereof and corresponding clusters, for each node in the strongly-connected clusters and a non-strongly connected cluster between the strongly-connected clusters; creating a graph consisting of parallelization tables; converting the graph consisting of the parallelization tables into a series-parallel graph; and merging the parallelization tables for each serial path merging the parallelization tables for each parallel section. Then, based on the number of processors and the cost value in the unified parallelization table, a best entry is selected and an executable code to be allocated to each processor is generated.

### FIELD OF THE INVENTION

This invention relates to a technique for speeding up the execution of a program in a multi-core or multiprocessor system.

### BACKGROUND OF THE INVENTION

Recently, a so-called multiprocessor system having multiple processors has been used in the fields of scientific computation, simulation and the like. In such a system, an application program generates multiple processes and allocates the processes to individual processors. These processors go through a procedure while communicating with each other using a shared memory space, for example.

As a field of simulation, the development of which has been particularly facilitated only recently, there is simulation software for plants of mechatronics such as robots, automobiles and airplanes. With the benefit of the development of electronic components and software technology, most parts of a robot, an automobile, an airplane or the like are electronically controlled by using wire connections laid like a network of nerves, a wireless LAN and the like.

Although these mechatronics products are mechanical devices in nature, they also incorporate large amounts of control software. Therefore, the development of such a product has required a long time period, enormous costs and a large pool of manpower to develop a control program and to test the program.

As a conventional technique for such a test, there is HILS (Hardware In the Loop Simulation). Particularly, an environment for testing all the electronic control units (ECUs) in an automobile is called full-vehicle HILS. In the full-vehicle HILS, a test is conducted in a laboratory according to a predetermined scenario by connecting a real ECU to a dedicated hardware device emulating an engine, a transmission mechanism, or the like. The output from the ECU is input to a monitoring computer, and further displayed on a display to allow a person in charge of the test to check if there is any abnormal action while viewing the display.

However, in HILS, the dedicated hardware device is used, and the device and the real ECU have to be physically wired. Thus, HILS involves a lot of preparation. Further, when a test is conducted by replacing the ECU with another, the device and the ECU have to be physically reconnected, requiring even more work. Further, since the test uses the real ECU, it takes an actual time to conduct the test. Therefore, it takes an immense amount of time to test many scenarios. In addition, the hardware device for emulation of HILS is generally very expensive.

Therefore, there has recently been a technique using software without using such an expensive emulation hardware device. This technique is called SILS (Software In the Loop Simulation), in which components to be mounted in the ECU, such as a microcomputer and an I/O circuit, a control scenario, and all plants such as an engine and a transmission, are configured by using a software simulator. This enables the test to be conducted without the hardware of the ECU.

As a system for supporting such a configuration of SILS, for example, there is a simulation modeling system, MATLAB®/Simulink® available from Mathworks Inc. In the case of using MATLAB®/Simulink®, functional blocks indicated by rectangles are arranged on a screen through a graphical interface as shown in FIG. 1, and a flow of processing as indicated by arrows is specified, thereby enabling the creation of a simulation program. The diagram of these blocks represents processing for one time step of simulation, and this is repeated predetermined times so that the time-series behavior of the system to be simulated can be obtained.

Thus, when the block diagram of the functional blocks or the like is created on MATLAB®/Simulink®, it can be converted to C source code of an equivalent function using the function of Real-Time Workshop®. This C source code is so compiled that simulation can be performed as SILS on another computer system.

Therefore, as shown in FIG. 2(a), a technique has been conventionally carried out, in which the functional blocks are classified into multiple clusters, like clusters A, B, C and D, and allocated to individual CPUs, respectively. For such clustering, for example, a technique, known as compiler technology, for detecting strongly-connected components is used. The main purpose of clustering is to reduce the communication costs for functional blocks in the same cluster. FIG. 2(b) is a diagram representing individual clusters A, B, C and D in the form of blocks.

In the meantime, techniques for allocating multiple tasks or processes to respective processors to parallelize the processes in a multiprocessor system are described in the following documents.

Japanese Patent Application Publication No. 9-97243 is to shorten the turnaround time of a program composed of parallel tasks in a multiprocessor system. In a system disclosed, a source program of a program composed of parallel tasks is complied by a compiler to generate a target program. The compiler generates an inter-task communication amount table holding the amount of data of inter-task communication performed between tasks of the parallel tasks. From the inter-task communication amount table and a processor communication cost table defining data communication time per unit data in a set of all processors in the multiprocessor system, a task scheduler decides and registers, in a processor control table, that a processor whose time of inter-task communication becomes the shortest is allocated to each task of the parallel tasks.

Japanese Patent Application Publication No. 9-167144 discloses a program creation method for altering a parallel program in which plural kinds of operation procedures and plural kinds of communication procedures corresponding to communication processing among processors are described to perform parallel processing. When the communication amount of communication processing performed according to a currently used communication procedure is assumed to be increased, if the time from the start of the parallel processing until the end of thereof is shortened, the communication procedures in the parallel program are rearranged to change the description content to merge two or more communication procedures.

Japanese Patent Application Publication No. 2007-048052 is related to a compiler for optimizing parallel processing. The compiler records the number of execution cores as the number of processor cores for executing a target program. First, the compiler detects dominant paths as candidates for execution paths to be continuously executed by a single processor core in the target program. Next, the compiler selects a number of dominant paths equal to or smaller than the number of execution cores to generate a cluster of tasks to be executed in parallel or continuously by a multi-core processor. Next, the compiler calculates an execution time when a number of processor cores, equal to one or more natural numbers, execute generated clusters on a cluster basis for each of the one or more natural numbers equal to or smaller than the number of execution cores. Then, based on the calculated execution time, the compiler selects the number of processor cores to be allocated to execute each cluster.

However, these disclosed techniques cannot always achieve efficient parallelization when directed graph processing as shown in FIG. 2(b) like the execution of a simulation program is repeatedly performed.

On the other hand, a technique adapted to the parallelization of clusters shown in FIG. 2(b) is described in the following document: Neil Vachharajani, Ram Rangan, Easwaran Raman, Matthew J. Bridges, Guilherme Ottoni, David I. August, “Speculative Decoupled Software Pipelining,” In proceedings of the 16th International Conference on Parallel Architecture and Compilation Techniques. Each of multiple clusters can be allocated to each individual processor to implement pipelines as shown in FIG. 3.

### SUMMARY OF THE INVENTION

It is an object of this invention to provide a parallelization technique capable of taking advantage of parallelism in strongly-connected components and enabling a high-speed operation in such a simulation model that tends to increase the size of the strongly-connected components.

As a precondition of carrying out this invention, it is assumed that the system is in a multi-core or multiprocessor environment. In such a system, a program for parallelization is created by, but should not be limited to, a simulation modeling tool such as MATLAB®/Simulink®. In other words, the program is described with control blocks connected by directed edges indicating a flow of processes.

The first step according to the present invention is to select highly predictable edges from the edges.

In the next step, a processing program according to the present invention finds strongly-connected clusters. After that, strongly-connected clusters each including only one block and adjacent to each other are merged in a manner not to impede parallelization and the merged cluster is set as a non-strongly connected cluster.

In the next step, the processing program according to the present invention creates a parallelization table for each of the formed strongly-connected clusters and non-strongly connected clusters.

In the next step, the processing program according to the present invention converts, into a series-parallel graph, a graph having strongly-connected clusters and non-strongly connected clusters as nodes.

In the next step, the processing program according to the present invention merges parallelization tables based on the hierarchy of the series-parallel graph.

In the next step, the processing program according to the present invention selects the best configuration from the parallelization tables obtained, and based on this configuration, clusters are actually allocated to cores or processors, individually.

According to this invention, a parallelization technique is used, which takes advantage of parallelism of strongly-connected components in such a simulation model that tends to increase the size of the strongly-connected components, thereby increasing the operation speed.

### BRIEF DESCRIPTION OF THE DRAWINGS

FIG. 1 shows an example of a block diagram;

FIG. 2 shows an example of a clustered block diagram;

FIG. 3 shows an example of pipelined block diagram;

FIG. 4 is a diagram showing an example of hardware for carrying out the present invention;

FIG. 5 shows a functional block diagram;

FIG. 6 is a general flowchart of overall processing;

FIG. 7 shows an example of a block diagram;

FIG. 8 shows an example of a block diagram after removing a predictable edge;

FIG. 9 shows an example of a clustered block diagram;

FIG. 10 shows an example of a parallelization table;

FIG. 11 is a diagram showing correspondences between clusters and parallelization tables;

FIG. 12 shows a graph generated from the parallelization tables;

FIG. 13 is a diagram showing merging processing for parallelization tables;

FIG. 14 shows an example of a merged parallelization table;

FIG. 15 is a flowchart showing SCC detection processing;

FIG. 16 is a flowchart showing SCC merging processing;

FIG. 17 is a flowchart showing Clear_path_and_assign ( ) processing;

FIG. 18 is a flowchart showing processing for calculating a parallelization table for each cluster;

FIG. 19 is flowchart showing processing for calculating a parallelization table for each cluster;

FIG. 20 is a flowchart showing processing for constructing a graph for parallelization tables;

FIG. 21 is a flowchart showing processing for unifying parallelization tables;

FIG. 22 is a flowchart showing get_series_parallel_nested_tree ( ) processing;

FIG. 23 is a flowchart showing get_table ( ) processing;

FIG. 24 is a flowchart showing series_merge ( ) processing;

FIG. 25 is a flowchart showing parallel_merge ( ) processing;

FIG. 26 is a flowchart showing merge_clusters_in_shared ( ) processing; and

FIG. 27 is a flowchart showing processing for selecting the best configuration from the unified parallelization table.

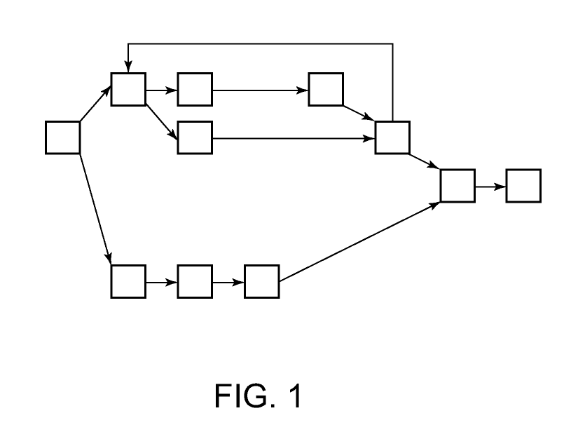

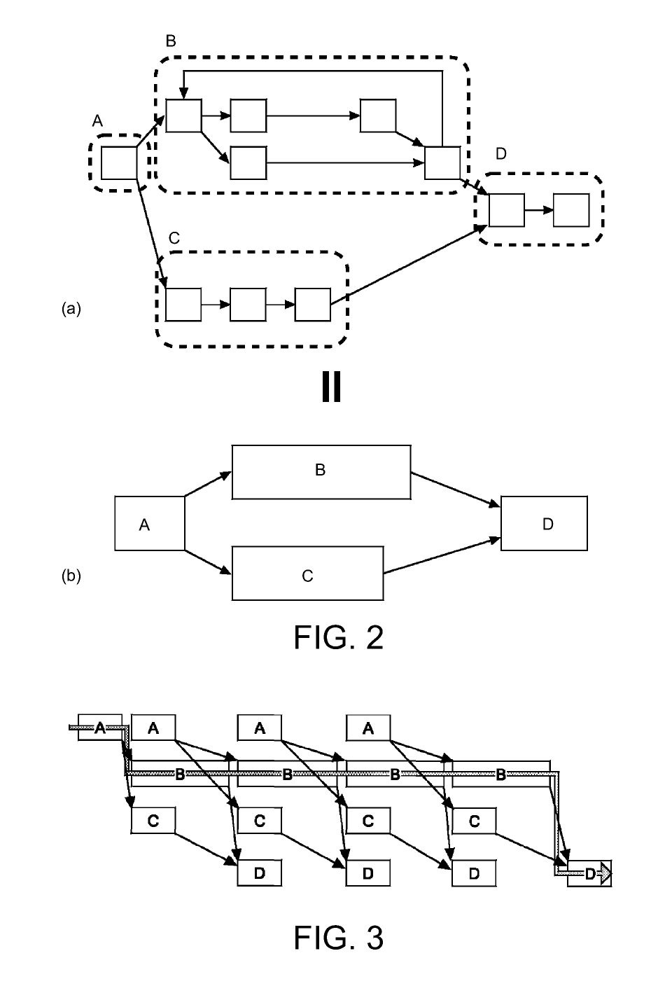

### DETAILED DESCRIPTION OF THE INVENTION

A configuration and processing of one preferred embodiment of the present invention will now be described with reference to the accompanying drawings. In the following description, the same components are denoted by the same reference numerals throughout the drawings unless otherwise noted. Although the configuration and processing are described here as one preferred embodiment, it should be understood that the technical scope of present invention is not intended to be limited to this embodiment.

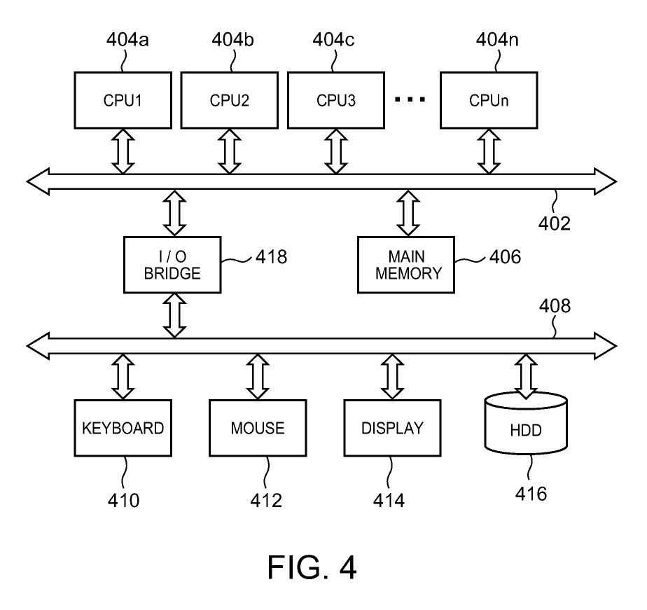

First, the hardware of a computer used to carry out the present invention will be described with reference to FIG. 4. In FIG. 4, multiple CPUs, i.e., CPU1 404a, CPU2 404b, CPU3 404c, . . . CPUn 404n are connected to a host bus 402. A main memory 406 is also connected to the host bus 402 to provide the CPU1 404a, CPU2 404b, CPU3 404c, . . . CPUn 404n with memory spaces for arithmetic processing.

A keyboard 410, a mouse 412, a display 414 and a hard disk drive 416 are connected to an I/O bus 408. The I/O bus 408 is connected to the host bus 402 through an I/O bridge 418. The keyboard 410 and the mouse 412 are used by an operator to perform operations, such as to enter a command and click on a menu. The display 414 is used to display a menu on a GUI to operate, as required, a program according to the present invention to be described later.

IBM® System X can be used as the hardware of a computer system suitable for this purpose. In this case, for example, Intel® Xeon® may be used for CPU1 404a, CPU2 404b, CPU3 404c, . . . CPUn 404n, and the operating system may be Windows® Server 2003. The operating system is stored in the hard disk drive 416, and read from the hard disk drive 416 into the main memory 406 upon startup of the computer system.

Use of a multiprocessor system is required to carry out the present invention. Here, the multiprocessor system generally means a system intended to use one or more processors having multiple cores of processor functions capable of performing arithmetic processing independently. It should be appreciated that the multiprocessor system may be either of a multi-core single-processor system, a single-core multiprocessor system and a multi-core multiprocessor system.

Note that the hardware of the computer system usable for carrying out the present invention is not limited to IBM® System X and any other computer system can be used as long as it can run a simulation program of the present invention. The operating system is also not limited to Windows®, and any other operating system such as Linux® or Mac OS® can be used. Further, a POWER™ 6-based computer system such as IBM® System P with operating system AIX™ may also be used to run the simulation program at high speed.

Also stored in the hard disk drive 416 are MATLAB®/Simulink®, a C compiler or C++ compiler, modules for analysis, flattening, clustering and unrolling according to the present invention to be described later, a code generation module for generating codes to be allocated to the CPUs, a module for measuring an expected execution time of a processing block, etc., and they are loaded to the main memory 406 and executed in response to a keyboard or mouse operation by the operator.

Note that a usable simulation modeling tool is not limited to MATLAB®/Simulink®, and any other simulation modeling tool such as open-source Scilab/Scicos can be employed.

Otherwise, in some cases, the source code of the simulation system can also be written directly in C or C++ without using the simulation modeling tool. In this case, the present invention is applicable as long as all the functions can be described as individual functional blocks dependent on each other.

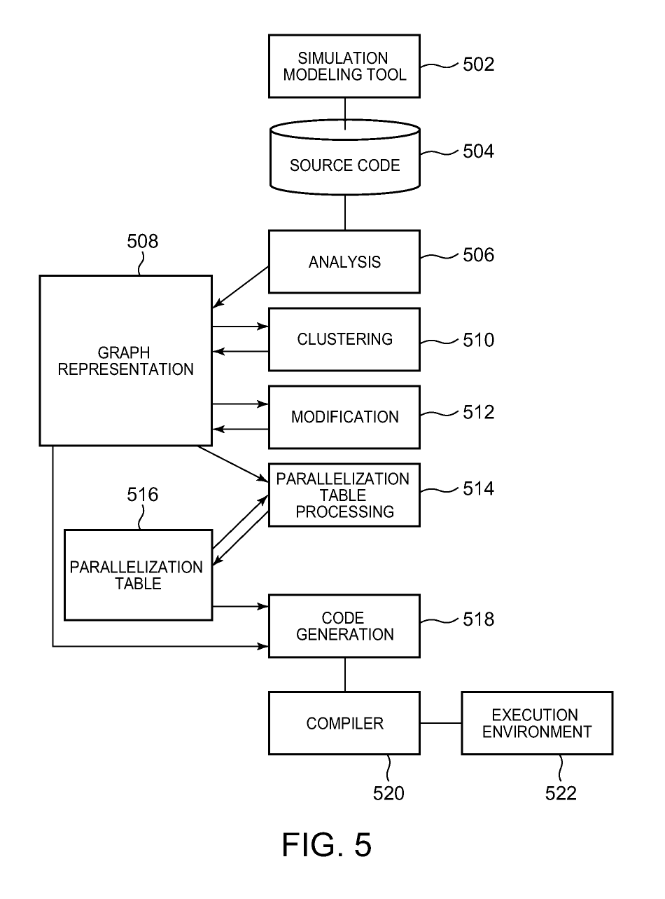

FIG. 5 is a functional block diagram according to the embodiment of the present invention. Basically, each block corresponds to a module stored in the hard disk drive 416.

In FIG. 5, a simulation modeling tool 502 may be any existing tool such as MATLAB®/Simulink® or Scilab/Scicos. Basically, the simulation modeling tool 502 has the function of allowing the operator to arrange the functional blocks on the display 414 in a GUI fashion, describe necessary attributes such as mathematical expressions, and associate the functional blocks with each other if necessary to draw a block diagram. The simulation modeling tool 502 also has the function of outputting C source code including the descriptions of functions equivalent to those of the block diagram. Any programming language other than C can be used, such as C++ or FORTRAN. Particularly, an MDL file to be described later is in a format specific to Simulink® to describe the dependencies among the functional blocks.

The simulation modeling tool can also be installed on another personal computer so that source code generated there can be downloaded to the hard disk drive 416 via a network or the like.

The source code 504 thus output is stored in the hard disk drive 416.

An analysis module 506 receives the input of the source code 504, parses the source code 504 and converts the connections among the blocks into a graph representation 508. It is preferred to store data of the graph representation 508 in the hard disk drive 416.

A clustering module 510 reads the graph representation 508 to perform clustering by finding strongly-connected components (SCC). The term “strongly-connected” means that there is a directed path between any two points in a directed graph. The term “strongly-connected component” means a subgraph of a given graph. The subgraph itself is strongly-connected so that if any vertex is added, the subgraph will be no longer strongly-connected.

A parallelization table processing module 514 has the function of creating a parallelization table 516 by processing to be described later based on the clusters obtained by the clustering module 510 performing clustering.

It is preferred that the created parallelization table 516 be placed in the main memory 406, but it may be placed in the hard disk drive 416.

A code generation module 518 refers to the graph representation 508 and the parallelization table 516 to generate source code to be compiled by a compiler 520. As the programming language assumed by the compiler 520, any programming language programmable in conformity to a multi-core or multiprocessor system, such as C, C++, C#, or Java™, can be used, and the code generation module 518 generates source code for each cluster according to the programming language.

An executable binary code (not shown) generated by the compiler 520 for each cluster is allocated to a different core or processor based on the content described in the parallelization table 516 or the like, and executed in an execution environment 522 by means of the operating system.

Processing of the present invention will be described in detail below according to a series of flowcharts, but before that, the definition of terms and notation will be given.

Set
   |X| represents the number of elements included in set X.

[symbol] X represents a complementary set of the set X.

X−Y=X∩ [symbol] Y

X[i] is the i-th element of set X.

MAX(X) is the largest value recorded in the set X.

FIRST(X) is the first element of the set X.

SECOND(X) is the second element of the set X.

Graph

Graph G is represented by <V, E>.

V is a set of nodes in the graph G.

E is a set of edges connecting vertices (nodes) in the graph G.

PARENT(v) is a set of parent nodes of nodes v (εV) in the graph G.

CHILD(v) is a set of child nodes of nodes v (εV) in the graph G.

SIBLING(v) is defined by {c:c!=v, cεCHILD(p), pεPARENT(v)}.

With respect to edge e=(u, v), (uεV, vεV),

SRC(e):=u

DEST(e):=v

Cluster

Cluster means a set of blocks. SCC is also a set of blocks, which is of a kind of cluster.

WORKLOAD(C) is the workload of cluster C. The workload of the cluster C is calculated by summing the workloads of all the blocks in the cluster C.

START(C) represents the starting time of the cluster C when static scheduling is performed on a set of clusters including the cluster C.

END(C) represents the ending time of the cluster C when static scheduling is performed on the set of clusters including the cluster C.

Parallelization Table T

T is a set of entries I as shown below.

I:=<number of processors, length of schedule (also referred to as cost and/or workload), set of clusters>

ENTRY(T, i) is an entry in which the first element is i in the parallelization table T.

LENGTH(T, i) is the second element of the entry in which the first element is i in the parallelization table T. If such an entry does not exist, return ∞.

CLUSTERS(T, i) is a set of clusters recorded in the entry in which the field of the processor is i in the parallelization table T.

Series-Parallel Graph

series-parallel nested tree Gₛₚ₋ₜᵣₑₑ is a binary tree represented by <Vₛₚ₋ₜᵣₑₑ, Eₛₚ₋ₜᵣₑₑ>.

Vₛₚ₋ₜᵣₑₑ represents a set of nodes of Gₛₚ₋ₜᵣₑₑ, in which each node consists of a set (f, s) of edges and symbols. Here, fεEₚₜ₋ₛₚ (where Eₚₜ₋ₛₚ is a set in which edges in a graph are elements) is sε{“L”, “S”, “P”}.

“L” is a symbol representing the type of leaf, “S” is of series and “P” is of parallel.

Eₛₚ₋ₜᵣₑₑ is a set of edges (u, v) of the tree Gₛₚ₋ₜᵣₑₑ.

EDGE (n) (nεVₛₚ₋ₜᵣₑₑ) is the first element of n.

SIGN (n) (nεVₛₚ₋ₜᵣₑₑ) is the second element of n.

LEFT (n) (nεVₛₚ₋ₜᵣₑₑ) is a left child node of node n in the tree G_{sp-tree .}

RIGHT (n) (nεVₛₚ₋ₜᵣₑₑ) is a right child node of node n in the tree G_{sp-tree .}

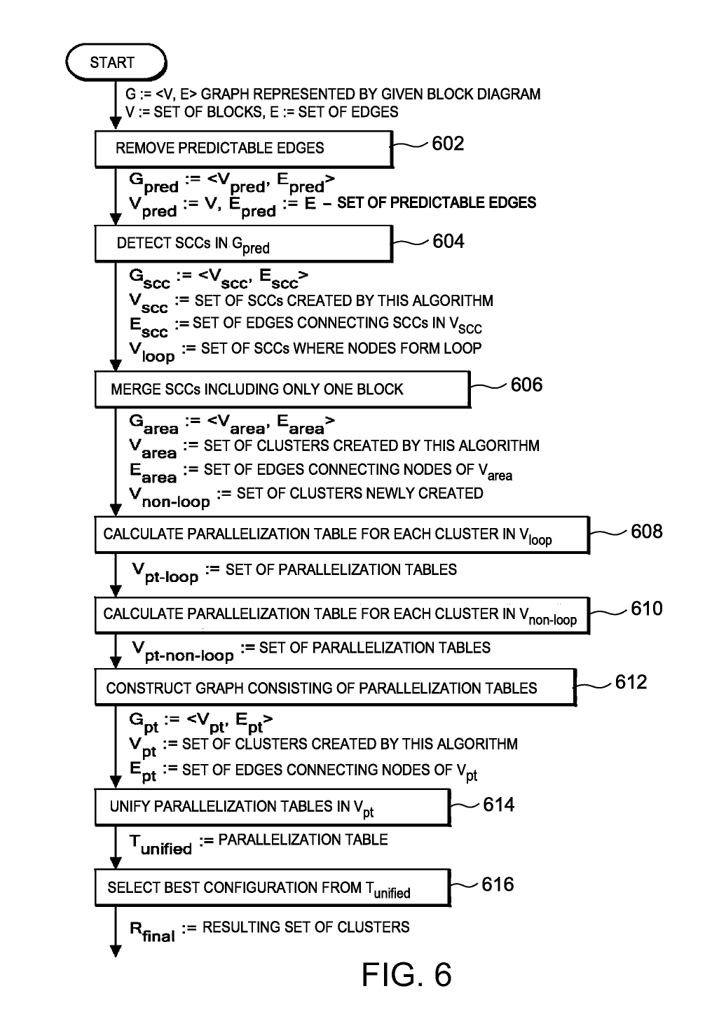

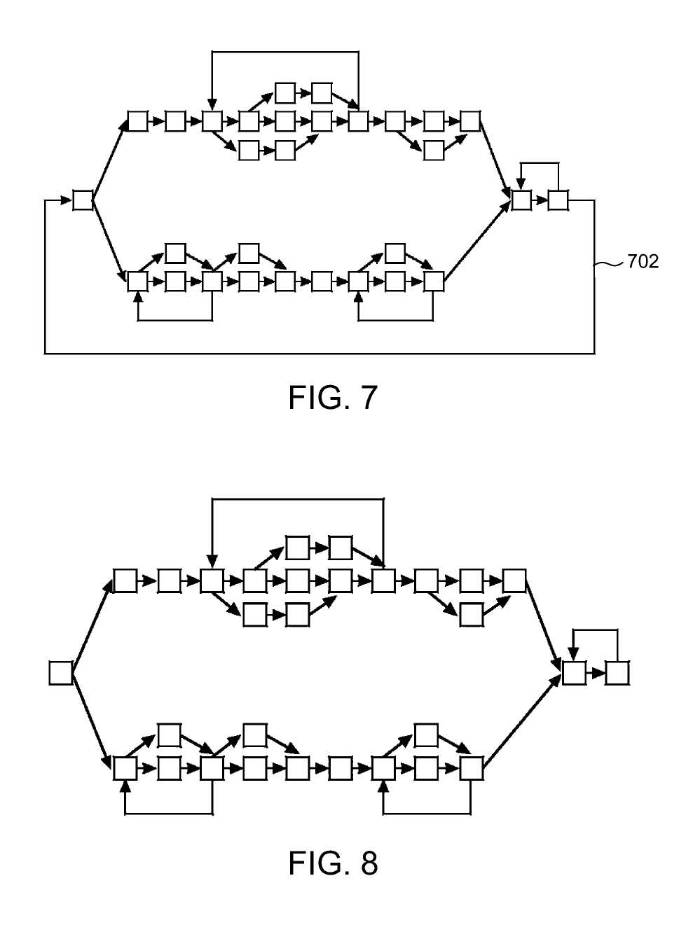

Referring to FIG. 6, a general flowchart of the present invention will be described. FIG. 7 shows a diagram in which a block diagram created by the simulation modeling tool 502 is converted by the analysis module into a graph representation.

First, this graph is represented by G:=<V, E>, where V is a set of blocks and E is a set of edges.

Returning to FIG. 6, predictable edges are removed in step 602. In view of the characteristics of the model, it is assumed that the predictable edges are selected in advance manually by a person who created the simulation model.

The graph representation after the predictable edges are thus removed is represented as G_{pred}:=<V_{pred}, E_{pred}>. In this case, V_{pred}=V and E_{pred}=E−Set of predictable edges.

The predictable edge is to select a signal (an edge on the block diagram) generally indicative of the speed of an object or the like, which is continuous and shows no acute change in a short time. Typically, it is possible to have a model creator write annotation on the model so that the compiler can know which edge is predictable.

FIG. 8 shows a block diagram in which a predictable edge is removed from the graph in FIG. 7. In FIG. 7, 702 is the predictable edge.

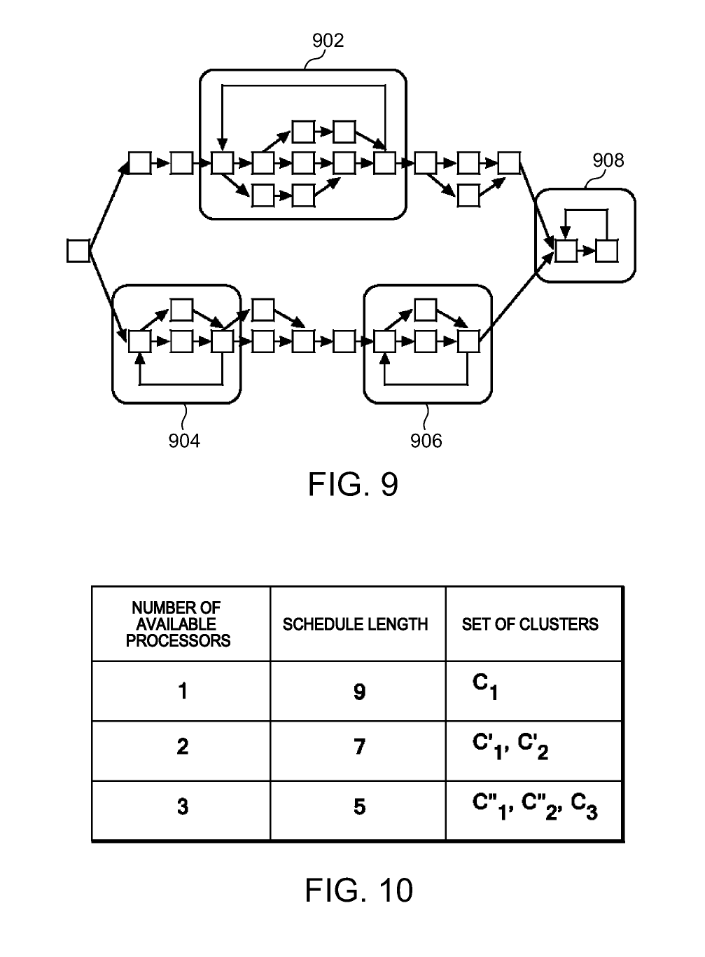

In step 604, the clustering module 510 detects strongly-connected components (SCCs). In FIG. 9, the SCCs thus detected and including one or more blocks are clusters indicated as 902, 904, 906 and 908. Suppose that the other blocks that are not included in the clusters 902, 904, 906 and 908 are SCCs each consisting of one block.

Using the SCCs thus detected, the graph of SCCs are represented as

G_{SCC}:=<V_{SCC}, E_{SCC}>.

Here, V_{SCC} is a set of SCCs created by this algorithm, and

E_{SCC} is a set of edges connecting SCCs in V_{SCC}.

Here, Vₗₒₒₚ as a set of SCCs, where nodes form a loop (i.e., SCCs each including two or more blocks), is also created.

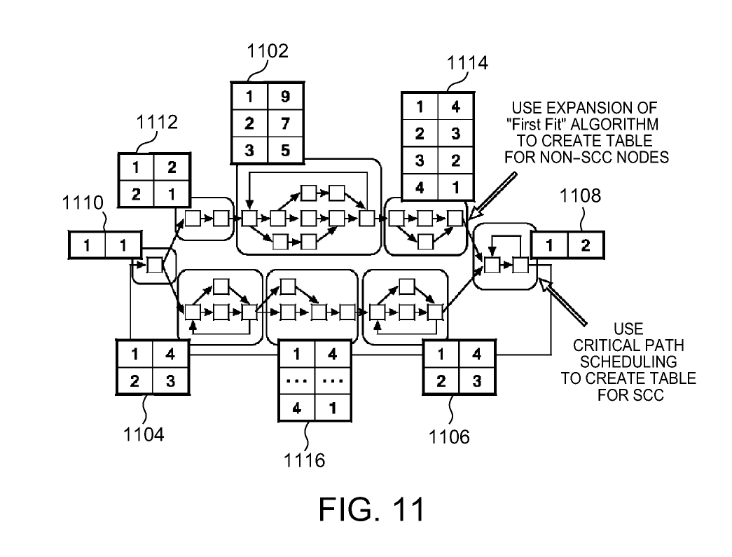

In step 606, adjacent SCCs each including only one block are merged by the clustering module 510 to form a non-SCC cluster so as not to impede subsequent parallelization. This situation is shown in FIG. 11.

The graph thus merged is represented as Gₐᵣₑₐ:=<Vₐᵣₑₐ, Eₐᵣₑₐ>.

Here, Vₐᵣₑₐ is a set of non-SCC clusters newly formed as a result of merging by this algorithm and SCC clusters without any change in this algorithm, and

Eₐᵣₑₐ is a set of edges connecting between elements of the V_{area .}

Here, Vₙₒₙ₋ₗₒₒₚ as a newly created set of non-SCC clusters is also created.

In step 608, the parallelization table processing module 514 calculates a parallelization table for each cluster in Vₗₒₒₚ. Thus, a set Vₚₜ₋ₗₒₒₚ of parallelization tables can be obtained.

In step 610, the parallelization table processing module 514 calculates a parallelization table for each cluster in Vₙₒₙ₋ₗₒₒₚ. Thus, a set Vₚₜ₋ₙₒₙ₋ₗₒₒₚ of parallelization tables can be obtained.

The parallelization tables thus obtained are shown in FIG. 11. The parallelization tables 1102, 1104, 1106 and 1108 are elements of the Vₚₜ₋ₗₒₒₚ, and the parallelization tables 1110, 1112, 1114 and 1116 are elements of the Vₚₜ₋ₙₒₙ₋ₗₒₒₚ. As shown in FIG. 10, the format of the parallelization tables is such that each entry consists of the number of usable processors, the workload and the set of clusters.

In step 612, the parallelization table processing module 514 constructs a graph in which each parallelization table is taken as a node.

The graph thus constructed is represented as Gₚₜ:=<Vₚₜ, Eₚₜ>.

Here, Vₚₜ is a set of parallelization tables created by this algorithm, and

Eₚₜ is a set of edges connecting between elements of the Vₚₜ.

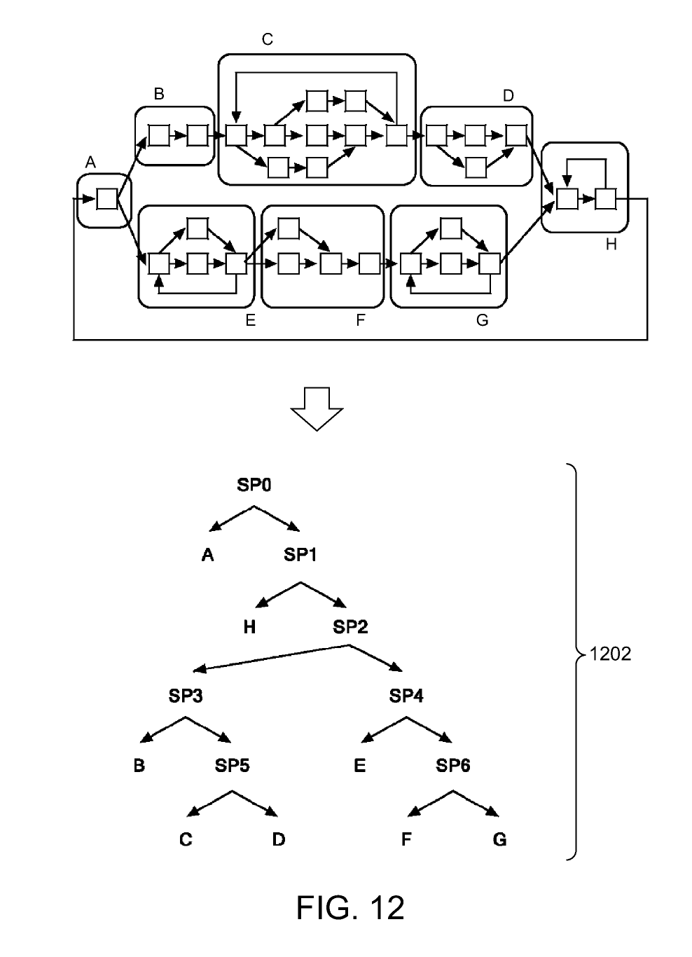

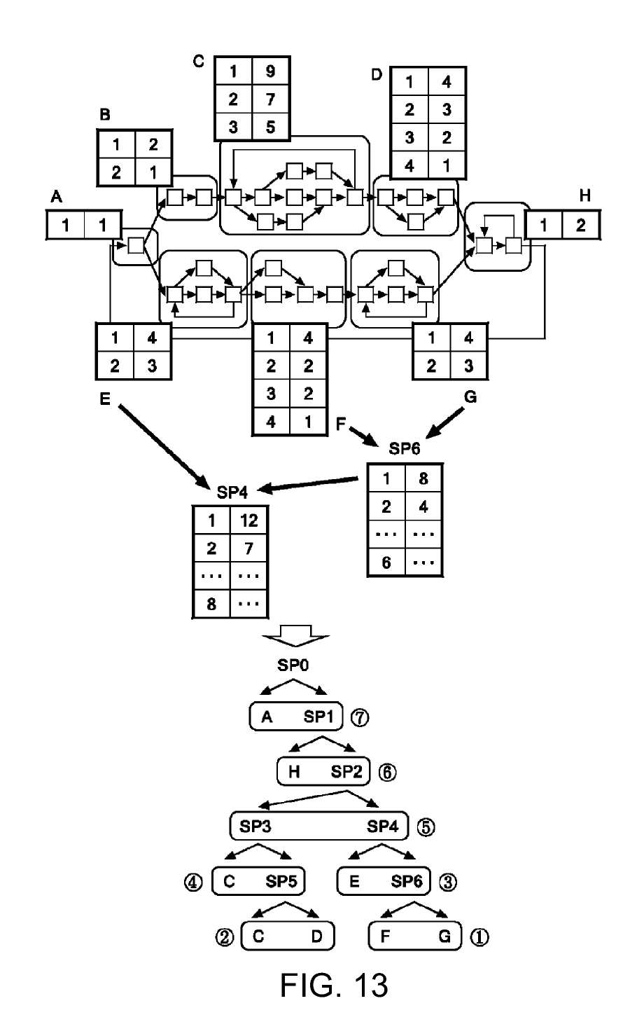

In step 614, the parallelization table processing module 514 unifies the parallelization tables in the Vₚₜ. In this unification processing, the Gₚₜ is first converted into a series-parallel graph and a series-parallel nested tree is generated therefrom. An example of the series-parallel nested tree generated here is shown at 1202 in FIG. 12. In this example, since the Gₚₜ is originally a series-parallel graph, the process of conversion to the series-parallel graph is not shown. According to the structure of the series-parallel nested tree thus generated, the parallelization tables are unified. This example is shown in FIG. 13. For example, parallelization tables F and G are merged to create new parallelization table SP6. Then, the SP6 is merged with parallelization table E to create new parallelization table SP4. Thus, merging of parallelization tables progresses according to the structure of the series-parallel nested tree and one parallelization table SP0 is finally created. This final one parallelization table is set as T_{unified}

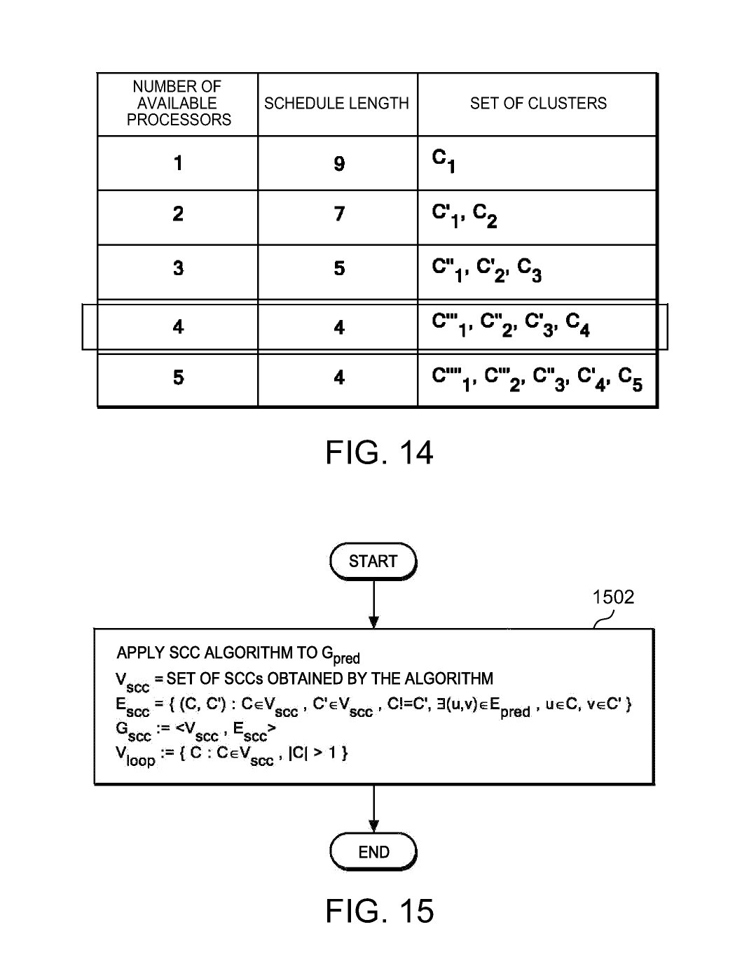

An example of the unified parallelization table T_{unified} is shown in FIG. 14.

The parallelization table processing module 514 selects the best configuration from the unified parallelization table T_{unified}. As a result, a resulting set of clusters R_{final} can be obtained. In the example of FIG. 14, the set R_{final}={C′″1, C″2, C′3, C4}.

The following describes each step of the general flowchart in FIG. 6 in more detail with reference to individual flowcharts.

FIG. 15 is a flowchart for describing, in more detail, step 604 of finding SCCs in FIG. 6. This processing is performed by the clustering module 510 in FIG. 5.

As shown, in step 1502, the following processing is performed:

An SCC algorithm is applied to the G_{pred}. For example, this SCC algorithm is described in “Depth-first search and linear graph algorithms,” R. Tarjan, SIAM Journal on Computing, pp. 146-160, 1972.

V_{SCC}=Set of SCCs obtained by the algorithm

E_{SCC}={(C, C′):CεV_{SCC}, C′εV_{SCC}, C!=C′, ∃(u, v)εE_{pred}, uεC, vεC′}

G_{SCC}=<V_{SCC}, E_{SCC}>

Vₗₒₒₚ={C:CεV_{SCC}, |C|>1}

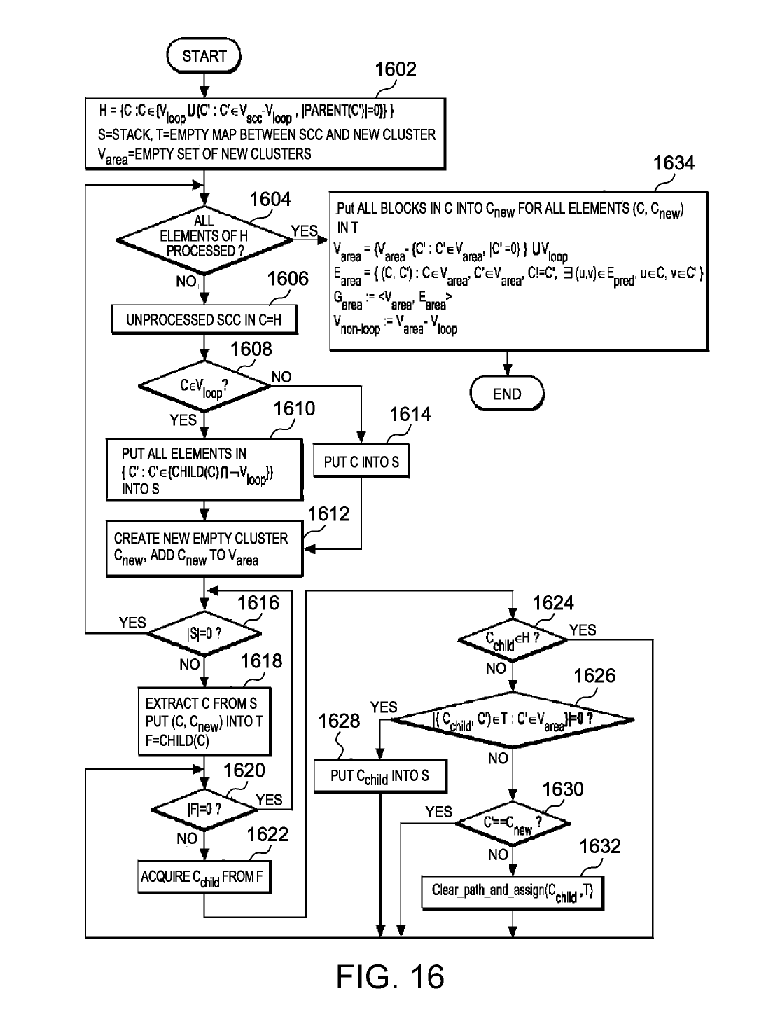

FIG. 16 is a flowchart for describing, in more detail, step 606 of merging SCCs including only one block in FIG. 6. This processing is also performed by the clustering module 510.

In step 1602, variables are set as follows:

### H={C:Cε{Vₗₒₒₚ∪{C′:C′εV_{SCC}−Vₗₒₒₚ, |PARENT (C′)|=0}}}

S=stack, T=Empty map between SCC and new cluster
Vₐᵣₑₐ=Empty set of new clusters.

In step 1604, it is determined whether all elements of H have been processed, and if not, the procedure proceeds to step 1606 in which one of unprocessed SCCs in H is extracted and set as C.

In step 1608, it is determined whether cεVₗₒₒₚ, and if so, the procedure proceeds to step 1610 in which processing for putting all elements in {C′:C′ε{CHILD(C)∩ [symbol] Vₗₒₒₚ}} into S is performed.

Here, [symbol] Vₗₒₒₚ is a complementary set of the Vₗₒₒₚ when the V_{SCC} is set as the whole set.

Next, the procedure proceeds to step 1612 in which a new empty cluster C_{new} is created and the C_{new} is added to Vₐᵣₑₐ.

Returning to step 1608, if not CεVₗₒₒₚ, C is put into S in step 1614, and the procedure proceeds to step 1612.

In step 1616, it is determined whether |S|=0, and if so, the procedure returns to step 1604.

If it is determined in step 1616 that it is not |S|=0, the procedure proceeds to step 1618 in which the following processing is performed:

Extract C from S

Put (C, C_{new}) into T

F=CHILD(C)

Next, the procedure proceeds to step 1620 in which it is determined whether |F|=0, and if so, the procedure returns to step 1620.

If it is determined in step 1620 that it is not |F|=0, the procedure proceeds to step 1622 in which processing for acquiring one element C_{child} from F is performed.

Next, in step 1624, it is determined whether C_{child}εH, and if so, the procedure returns to step 1620.

If it is determined in step 1624 that it is not C_{child}εH, it is determined in step 1626 whether |{(C_{child}, C′)εT: C′εVₐᵣₑₐ}|=0, and if so, C_{child} is put into S in step 1628, and after that, the procedure returns to step 1620.

If it is determined in step 1626 that it is not |{C_{child}, C′)εT:C′εVₐᵣₑₐ}|=0, it is determined in step 1630 whether C′==C_{new}, and if so, the procedure returns to step 1620.

If it is determined in step 1630 that it is not C′==C_{new}, a function as Clear_path_and_assign (C_{child}, T) is called in step 1632, and the procedure returns to step 1620.

The details of Clear_path_and_assign (C_{child}, T) will be described later.

Returning to step 1604, if it is determined that all elements C in H have been processed, the procedure proceeds to step 1634 to end the processing after performing the following:

Put all blocks in C into C_{new} for all elements (C, Cnew) in T

### Vₐᵣₑₐ={Vₐᵣₑₐ−{C′εVₐᵣₑₐ, |C′|=0}}∪Vₗₒₒₚ

Eₐᵣₑₐ={(C, C′):CεVₐᵣₑₐ, C′εVₐᵣₑₐ, C!=C′, ∃(u, v)εE_{pred}, uεC, vεC′}

### Gₐᵣₑₐ=<Vₐᵣₑₐ, Eₐᵣₑₐ>

### Vₙₒₙ₋ₗₒₒₚ=Vₐᵣₑₐ−Vₗₒₒₚ

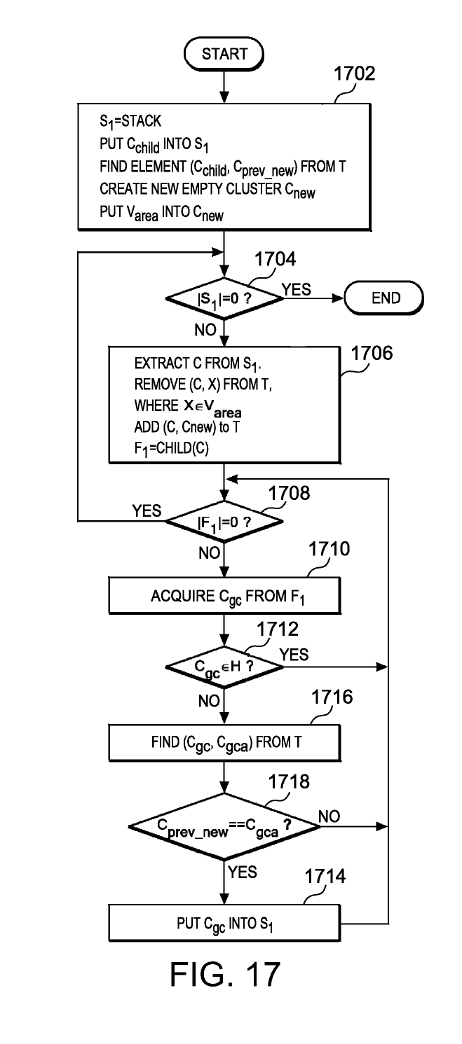

FIG. 17 is a flowchart showing the content of the function as Clear_path_and_assign (C_{child}, T) called in the flowchart of FIG. 16.

In step 1702, the following is set up:

### S₁=Stack

Put C_{child} into S1.
Find, from T, an element (C_{child}, Cₚᵣₑᵥ_{_{—}}_{new}) whose first element is C_{child}.
Create a new empty cluster C_{new}.
Put Vₐᵣₑₐ into C_{new}.

In step 1704, it is determined whether |S1|=0, and if so, the processing is ended.

If it is determined in step 1704 that it is not |S1|=0, the following processing is performed in step 1706:

Extract C from S₁.
Remove, from T, an element (C, X) whose first element is C, where XεVₐᵣₑₐ.

### Add (C, C_{new}) to T.

### F₁=CHILD(C)

In step 1708, it is determined whether |F1|=0, and if so, the procedure returns to step 1704, while if not, the procedure proceeds to step 1710 in which processing for acquiring C_{gc} from F₁ is performed.

Next, the procedure proceeds to step 1712 in which it is determined whether C_{gc}εH, and if so, the procedure returns to step 1708.

If it is determined in step 1712 that it is not C_{gc}εH, an element (C_{gc}, C_{gca}) whose first element is C_{gc} is found from T in step 1716, and in the next step 1718, it is determined whether Cₚᵣₑᵥ_{_{—}}_{new}=C_{gca}. If so, the procedure proceeds to step 1714 in which C_{gc} is put into S₁, and the procedure returns to step 1708 therefrom. If not, the procedure returns directly to step 1708.

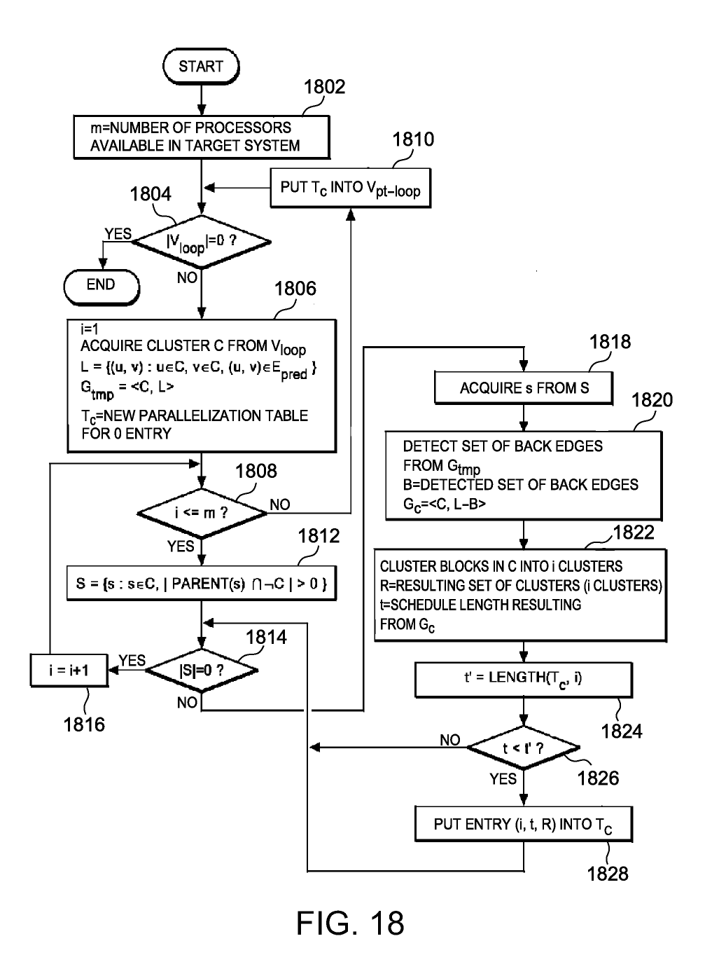

Referring next to a flowchart of FIG. 18, processing for calculating a parallelization table for each cluster in the Vₗₒₒₚ in step 608 of FIG. 6 will be described in more detail. This processing is performed by the parallelization table processing module 514 in FIG. 5.

In FIG. 18, the number of processors available in a target system is set to m in step 1802.

In step 1804, it is determined whether |Vₗₒₒₚ|=0, and if so, this processing is ended.

In the next step 1806, the following processing is performed:

i=1
Obtain cluster C from Vₗₒₒₚ.
L={(u, v):uεC, vεC, (u, v)εE_{pred}}

### Gₜₘₚ=<C, L>

Tc=New parallelization table for 0 entry

Here, Gₜₘₚ=<C, L> means that a graph in which blocks included in C are chosen as nodes and edges included in L are chosen as edges is represented as Gₜₘₚ.

In step 1808, it is determined whether i<=m, and if not, T_{c} is put into the Vₚₜ₋ₗₒₒₚ in step 1810 and the procedure returns to step 1804.

If it is determined in step 1808 that i<=m, the procedure proceeds to step 1812 in which S={s:sεC, |PARENT(s)∩ [symbol] C|>0} is set.

In the next step 1814, it is determined whether |S|=0, and if so, i is incremented by one and the procedure returns to step 1808.

If it is determined in step 1814 that it is not |S|=0, is obtained from S in step 1818, and in step 1820, processing for detecting a set of back edges from the Gₜₘₚ is performed. This is done, on condition that entry nodes in the Gₜₘₚ are s, by a method, for example, as described in the following document: Alfred V. Aho, Monica S. Lam, Ravi Sethi and Jeffrey D. Ullman, “Compilers: Principles, Techniques, and Tools (2nd Edition)”, Addison Wesley.

Here, the detected set of back edges is put as B.

Then, G,=<C, L-B>.

In step 1822, processing for clustering blocks in C into i clusters is performed. This is done, on condition that the number of available processors is i, by applying, to G_{c}, a multiprocessor scheduling method, for example, as described in the following document: Sih G. C., and Lee E. A. “A compile-time scheduling heuristic for interconnection-constrained heterogeneous processor architectures,” IEEE Trans. Parallel Distrib. Syst. 4, 2 (Feb. (1993)), 75-87. As a result of such scheduling, each block is executed by any processor, and a set of blocks to be executed by one processor is set as one cluster.

Then, the resulting set of clusters (i clusters) is put as R and the schedule length resulting from G, is t.

Here, the schedule length means time required from the start of the processing until the completion thereof as a result of the above scheduling.

At this time, the starting time of processing for a block to be first executed as a result of the above scheduling is set to 0, and the starting time and ending time of each cluster are recorded as the time at which processing for the first block is performed on a processor corresponding to the cluster and the time at which processing for the last block is ended, respectively, keeping them referable.

In step 1824, it is set as t′=LENGTH(T_{c}, i), and the procedure proceeds to step 1826 in which it is determined whether t<t′. If so, the entry (i, t, R) is put into T_{c} in step 1828 and the procedure returns to step 1814. If not, the procedure returns directly to step 1814.

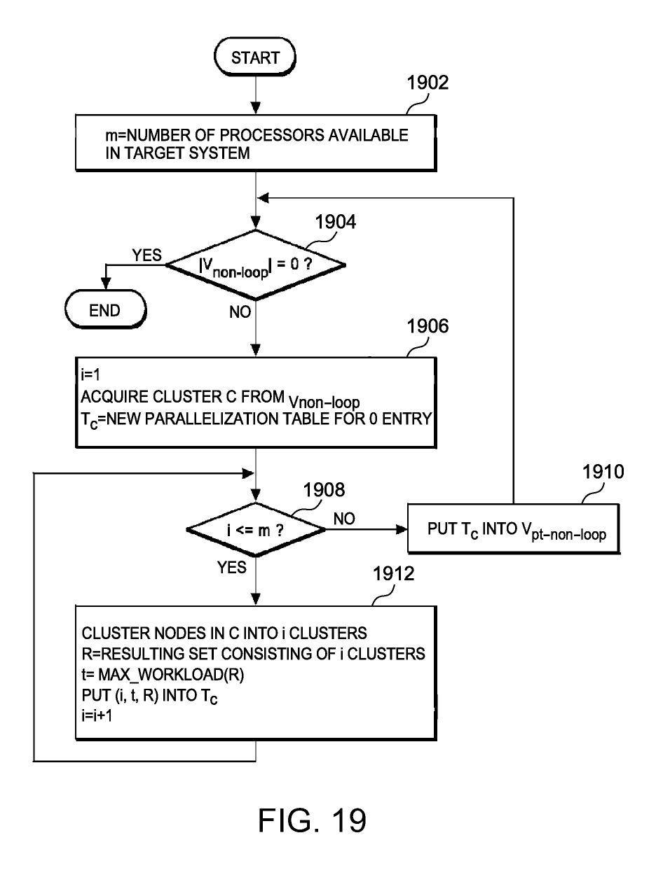

Referring next to a flowchart of FIG. 19, the processing for calculating a parallelization table for each cluster in the Vₙₒₙ₋ₗₒₒₚ in step 610 of FIG. 6 will be described in more detail. This processing is performed by the parallelization table processing module 514 in FIG. 5.

In FIG. 19, the number of processors available in a target system is set to m in step 1902.

In step 1904, it is determined whether |Vₙₒₙ₋ₗₒₒₚ|=0, and if so, this processing is ended.

If it is determined in step 1906 that it is not |Vₙₒₙ₋ₗₒₒₚ|=0, i is set to 1 in step 1906, cluster C is acquired from the Vₙₒₙ₋ₗₒₒₚ, and processing for setting, to T_{c}, a new parallelization table for 0 entry is performed.

In step 1908, it is determined whether i<=m, and if not, the procedure proceeds to step 1910 in which T, is put into Vₚₜ₋ₙₒₙ₋ₗₒₒₚ and the procedure returns to step 1904.

If it is determined in step 1908 that i<=m, processing for clustering nodes in C into i clusters is performed in step 1912. This is done, on condition that the number of available processors is i, by applying, to G_{c}, a multiprocessor scheduling method, for example, as described in the following document: G. Ottoni, R. Rangan, A. Stoler, and D. I. August, “Automatic Thread Extraction with Decoupled Software Pipelining,” In Proceedings of the 38th IEEE/ACM International Symposium on Microarchitecture, November 2005.

Then, the resulting set consisting of i clusters is set to R, MAX_WORKLOAD(R) is set to t, (i, t, R) is put into T_{c}, i is incremented by one, and the procedure returns to step 1908. At this time, the starting time of processing for a block to be first executed as a result of the above scheduling is set to 0, and the starting time and ending time of each cluster are recorded as the time at which processing for the first block is performed on a processor corresponding to the cluster and the time at which processing for the last block is ended, respectively, keeping them referable.

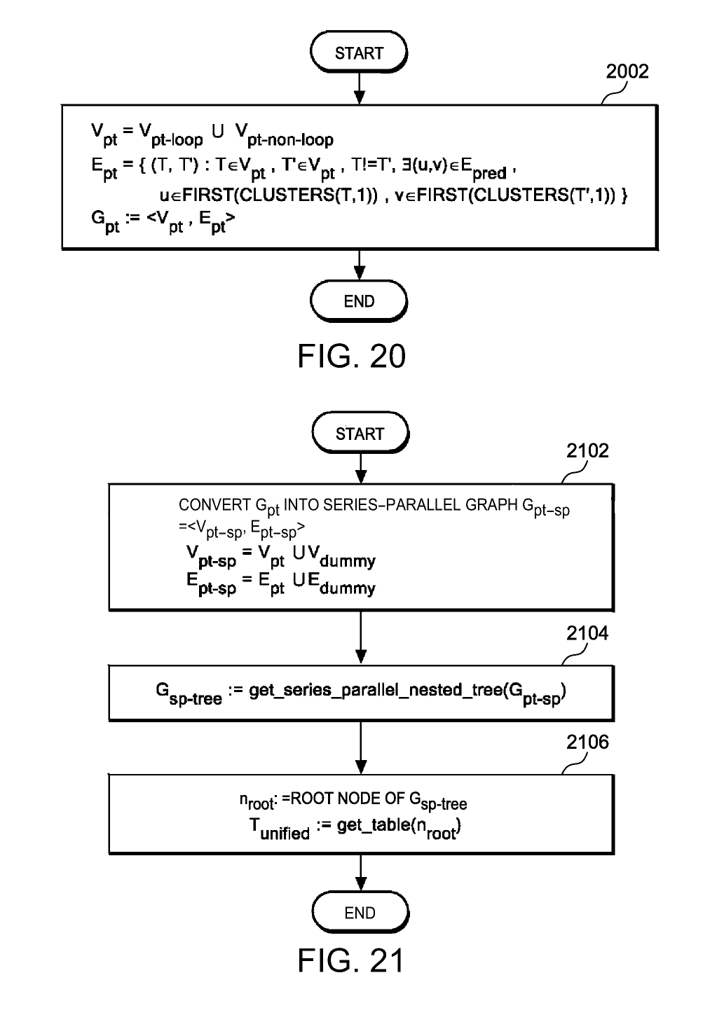

FIG. 20 is a flowchart showing processing for constructing a graph consisting of parallelization tables. This processing is performed by the parallelization table processing module 514 in FIG. 5. First, in step 2002, merging of two clusters can be obtained by Vₚₜ:=Vₚₜ₋ₗₒₒₚ.

Next, a set of edges of the graph consisting of the parallelization tables is given by the following equation:

Eₚₜ:={(T,T′):TεVₚₜ,T′εVₚₜ,T!=T′,∃(u,v)εE_{pred},uεFIRST(CLUSTERS(T, 1)),vεFIRST(CLUSTERS(T′, 1))}

As mentioned above, the graph consisting of the parallelization tables is constructed by Gₚₜ:=<Vₚₜ, Eₚₜ>. Note that CLUSTERS (T, 1) always returns one cluster. This is because the number of available processors is one as shown in the second argument.

In addition, edges having the same pair of end points are merged.

Referring next to a flowchart of FIG. 21, processing for unifying the parallelization tables will be described. This processing is performed by the parallelization table processing module 514 in FIG. 5.

First, in step 2102, processing for converting Gₚₜ into a series-parallel graph Gₚₜ₋ₛₚ=<Vₚₜ₋ₛₚ, Eₚₜ₋ₛₚ> is performed. This is done by a method, for example, as described in the following document: Arturo Gonzalez Escribano, Valentin Cardenoso Payo, and Arjan J. C. van Gemund, “Conversion from NSP to SP graphs,” Tech. Rep. TRDINFO-01-97, Universidad de Valladolid, Valladolid (Spain), 1997.

Next, Vₚₜ₋ₛₚ is obtained as follows:

### Vₚₜ₋ₛₚ=Vₚₜ∪V_{dummy}

Here, V_{dummy} is a set of dummy nodes added by this algorithm. Each dummy node is a parallelization table {(i, 0, φ):i=1, . . . , m} where m is the number of processors available in the target system.

Further, Eₚₜ₋ₛₚ is obtained as follows:

### Eₚₜ₋ₛₚ=EₚₜεE_{dummy}

Here, E_{dummy} is a set of dummy edges added by this algorithm to connect elements of the Vₚₜ₋ₛₚ.

In step 2104, Gₛₚ₋ₜᵣₑₑ is obtained by the following equation:

Gₛₚ₋ₜᵣₑₑ:=get_series_parallel_nested_tree(Gₚₜ₋ₛₚ)

Note that the function called get_series_parallel_nested_tree ( ) will be described in detail later.

In step 2106, nᵣₒₒₜ:=Root node of Gₛₚ₋ₜᵣₑₑ is set. This root node is a node having no parent node, and such a node exists only once in the G_{sp-tree .}

Next, T_{unified} is obtained by the following equation:

T_{unified}:=get_table(nᵣₒₒₜ)

Note that the function called get_table ( ) will be described in detail later.

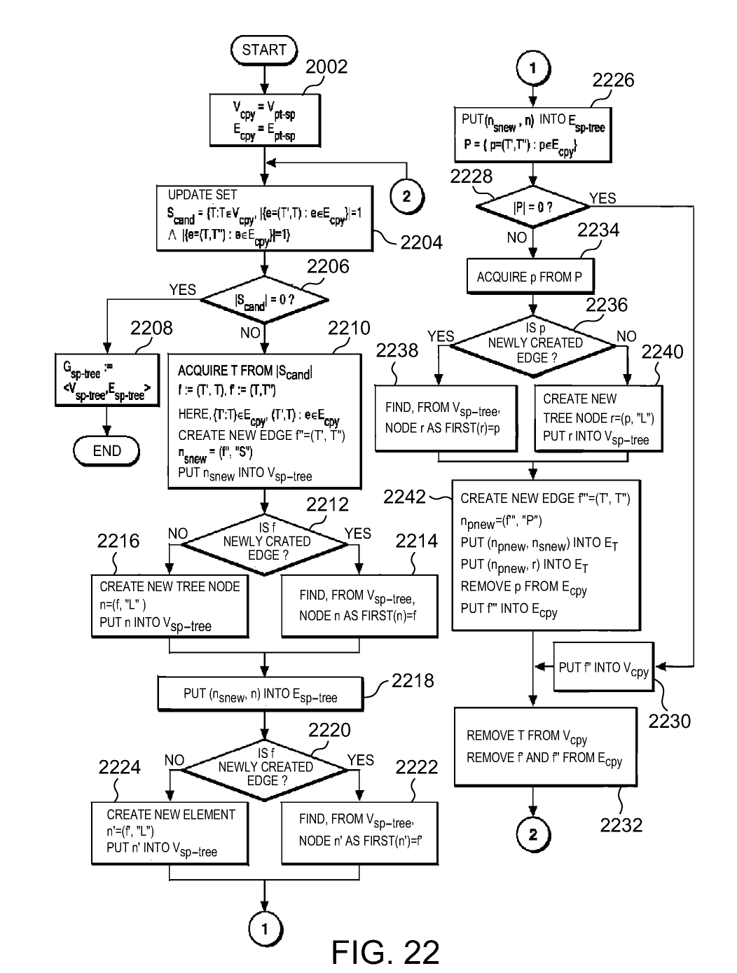

Referring next to a flowchart of FIG. 22, the operation of get_series_parallel_nested_tree(Gₚₜ₋ₛₚ) will be described.

First, in step 2202, copies are once made as V_{cpy}=Vₚₜ₋ₛₚ, E_{cpy}⁼Eₚₜ₋ₛₚ.

In step 2204, the set is updated by S_{cand}={T:TεV_{cpy}, |{e=(T′, T):eεE_{cpy}}|=1 [symbol] |{e=(T, T″): eεE_{cpy}}|=1}.

In step 2206, it is determined whether |S_{cand}|=0, and if so, Gₛₚ₋ₜᵣₑₑ:=<Vₛₚ₋ₜᵣₑₑ, Eₛₚ₋ₜᵣₑₑ> is set and processing is ended.

If it is determined in step 2206 that it is not |S_{cand}|=0, the procedure proceeds to step 2210 to perform the following processing:

First, acquire I from S_{cand}
f:=(T′, T), f′:=(T, T″)

### Here, (T′, T)εE_{cpy}, (T, T″)εE_{cpy}

Create new edge f″=(T′, T″).
n_{snew}=(f″, “S”)
Put n_{snew} into Vₛₚ₋ₜᵣₑₑ.

Next, the procedure proceeds to step 2212 in which it is determined whether f is a newly created edge. If so, the procedure proceeds to step 2214 to perform processing for finding, from the Vₛₚ₋ₜᵣₑₑ, node n as FIRST(n)=f is performed.

On the other hand, if it is determined in step 2212 that f is not a newly created edge, the procedure proceeds to step 2216 to create new tree node n=(f, “L”) and put n into the Vₛₚ₋ₜᵣₑₑ.

From step 2214 or 2216, the procedure proceeds to step 2218 in which processing for putting (n_{snew}, n) into the Eₛₚ₋ₜᵣₑₑ is performed.

Next, the procedure proceeds to step 2220 in which it is determined whether f′ is a newly created edge. If so, the procedure proceeds to step 2222 in which processing for finding, from the Vₛₚ₋ₜᵣₑₑ, node n′ as FIRST(n′)=f′ is performed.

On the other hand, if it is determined in step 2220 that f′ is not a newly created edge, the procedure proceeds to step 2224 to create new tree node n′=(f′, “L”) and put n′ into the Vₛₚ₋ₜᵣₑₑ.

From step 2222 or 2224, the procedure proceeds to step 2226 in which processing for putting (n_{snew}, n′) into the Eₛₚ₋ₜᵣₑₑ is performed. Further, P={p=(T′, T″):pεE_{cpy}} is set.

Next, in step 2228, it is determined whether |P|=0, and if so, the procedure proceeds to step 2230 in which f″ is put into the V_{cpy}. Then, in the next step 2232, T is removed from the V_{cpy}, f′ and f″ are removed from the E_{cpy}, and the procedure returns to step 2204.

Returning to step 2228, it is determined that it is not |P|=0, the procedure proceeds to step 2234 in which one element p is acquired from P.

Next, in step 2236, it is determined whether p is a newly created edge, and if so, processing for finding node r as FIRST(r)=p from the Vₛₚ₋ₜᵣₑₑ is performed in step 2238.

In step 2236, if it is determined that p is not a newly created edge, the procedure proceeds to step 2240 in which processing for creating new tree node r=(p, “L”) and putting r into the Vₛₚ₋ₜᵣₑₑ is performed.

From step 2238 or step 2240, the procedure proceeds to step 2242 in which processing for creating new edge f″′=(T′, T″), setting n_{pnew}=(f′″, “P”), putting (n_{pnew}, n_{snew}) into E_{T}, putting (n_{pnew}, r) into E_{T}, removing p from E_{cpy} and putting f′″ into E_{cpy} is performed.

From step 2242, the procedure returns to step 2204 via step 2232 already described above.

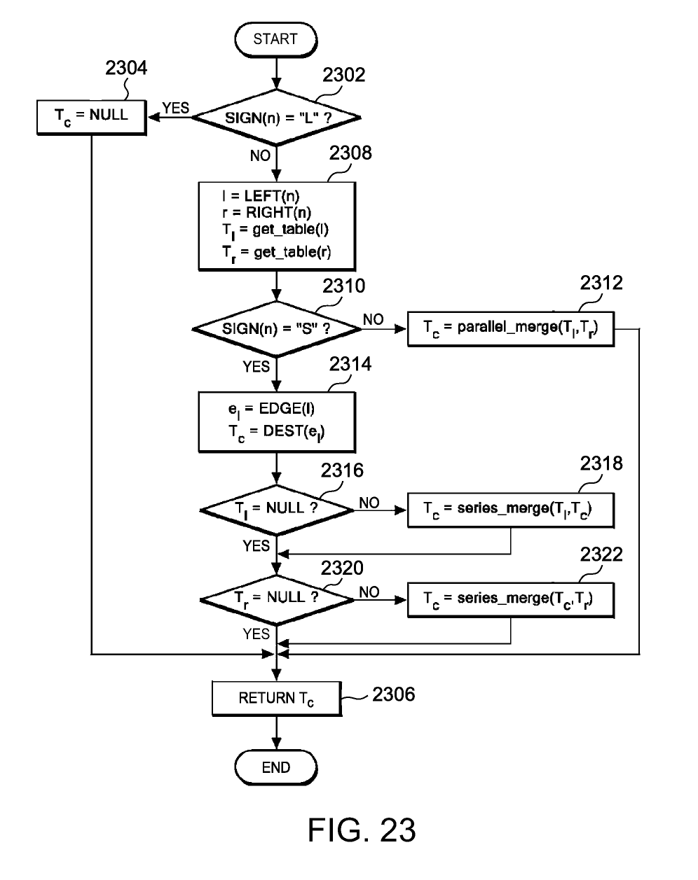

FIG. 23 is a flowchart showing the content of processing for the function called get_table ( ) in step 2106 of FIG. 21.

In FIG. 23, it is first determined in step 2302 whether SIGN(l)=“L.” Here, the function called SIGN ( ) returns elements in a set described as sε{“L”, “S”, “P”} in the set of nodes previously represented as a pair (f, s) of the tree Gₛₚ₋ₜᵣₑₑ, where “L” denotes the type of leaf, “S” of series and “P” of parallel.

If it is determined in step 2302 that SIGN(l)=“L,” the procedure proceeds to step 2304 in which Tc=NULL is set. Then, in step 2306, T_{c} is returned, and the processing is ended.

If it is determined in step 2302 that it is not SIGN(l)=“L,” the procedure proceeds to step 2308 in which l=LEFT (n), r=RIGHT (n), Tl=get_table (l) and Tr=get_table(r) are calculated. Since this flowchart is to perform processing on get_table ( ), get_table (l) and get_table(r) are recursive calls.

Next, the procedure proceeds to step 2310 in which it is determined whether SIGN(l)=“S.” If not, Tc=parallel_merge (Tₗ, Tᵣ) is set in step 2312, T_{c} is returned in step 2306, and the processing is ended. The details of parallel_merge ( ) will be described later.

If it is determined in step 2310 that SIGN (n)=“S,” eₗ=EDGE (l) and T_{c}=DEST (eₗ) are set in step 2314, and it is determined in step 2316 whether Tₗ=NULL. If not, T_{c}=series_merge (Tₗ, T_{C}) is set in step 2318, and the procedure proceeds to step 2320. If so, the procedure proceeds directly to step 2320. The details of series_merge ( ) will be described later.

Next, it is determined in step 2320 whether Tᵣ=NULL, and if not, T_{c}=series_merge (T_{c}, Tᵣ) is set in step 2322, and the procedure proceeds to step 2306. If so, the procedure proceeds directly to step 2306. Thus, Tc is returned and the processing is ended.

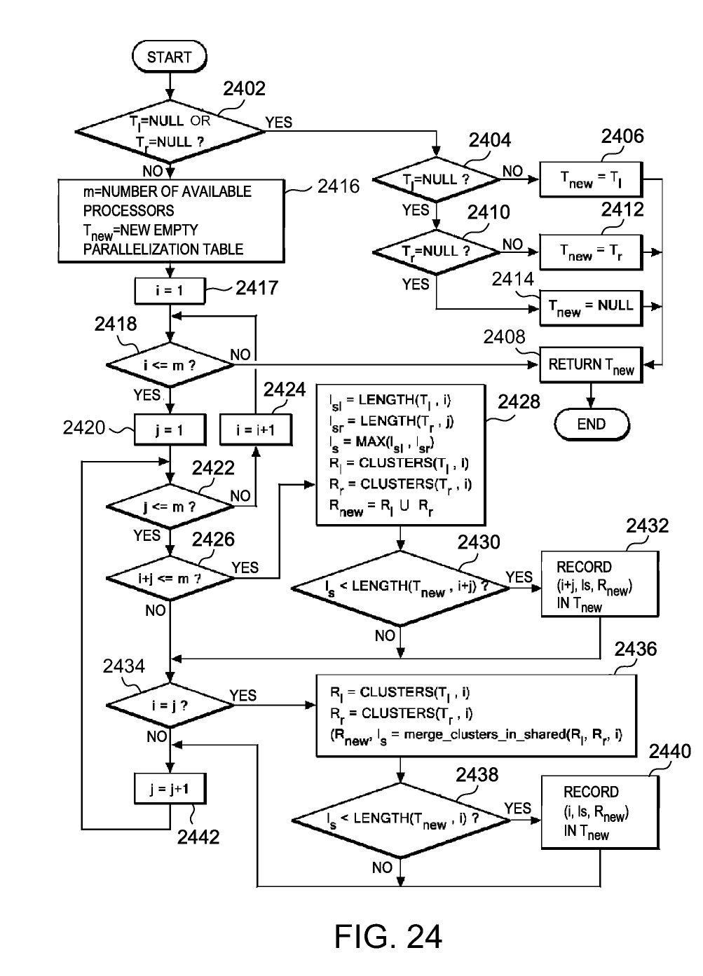

Referring next to a flowchart of FIG. 24, processing of series_merge (Tₗ, Tᵣ) will be described. First, in step 2402, it is determined whether T₁==NULL or Tᵣ==NULL. If so, the procedure proceeds to step 2404 in which it is determined whether T₁==NULL. If not, T_{new}=Tₗ is set in step 2406, T_{new} is returned in step 2408, and the processing is ended.

If Tₗ==NULL, the procedure proceeds to step 2410 in which it is determined whether Tᵣ==NULL. If not, T_{new}=Tᵣ is set in step 2412, T_{new} is returned in step 2408, and the processing is ended.

If Tᵣ==NULL, the procedure proceeds to step 2414 in which T_{new}=NULL is set, T_{new} is returned in step 2408, and the processing is ended.

If it is determined in step 2402 to be neither Tₗ==NULL nor Tᵣ==NULL, the procedure proceeds to step 2416 in which the number of available processors is set to m, and a new empty parallelization table is set to T_{new}.

Then, in step 2417, 1 is set to i, and it is determined in step 2418 whether i<=m. If it is not i<=m, the procedure proceeds to step 2408 to return T_{new} and end the processing.

If i<=m, j=1 is set in step 2420. Then, in step 2422, it is determined whether j<=m, and if not, i is incremented by one in step 2424 and the procedure returns to step 2418.

If it is determined in step 2422 that j<=m, the procedure proceeds to step 2426 in which it is determined whether i+j<=m. If so, the procedure proceeds to step 2428 in which the following processing is performed:

lₛₗ=LENGTH (Tₗ, i)
lₛᵣ=LENGTH (Tᵣ, j)
lₛ=MAX (lₛₗ, lₛᵣ)

### Rₗ=CLUSTERS (Tₗ, i)

### Rᵣ=CLUSTERS (Tᵣ, j)

### R_{new}=Rₗ∪Rᵣ

Following step 2428, it is determined in step 2430 whether lₛ<LENGTH (T_{new}, i+j), and if so, (i+j, lₛ, R_{new}) is recorded in T_{new} in step 2432. Then, the procedure proceeds to step 2434. If it is determined in step 2430 that it is not lₛ<LENGTH (T_{new}, i+j), the procedure proceeds directly to step 2434.

In step 2434, it is determined whether i=j, and if so, the following processing is performed in step 2436:

### Rₗ=CLUSTERS (Tₗ, i)

### Rᵣ=CLUSTERS (Tᵣ, j)

(R_{new}, lₛ)=merge_clusters_in_shared (Rₗ, Rᵣ, i)

Note that processing for merge_clusters_in_shared ( ) will be described in detail later.

Following step 2436, it is determined in step 2438 whether lₛ<LENGTH (T_{new}, i), and if so, (i, lₛ, R_{new}) is recorded in T_{new} in step 2440. Then, the procedure proceeds to step 2442. If it is determined in step 2430 that it is not lₛ<LENGTH (T_{new}, i), the procedure proceeds directly to step 2442.

If it is determined in step 2434 that it is not i=j, the procedure proceeds directly from step 2434 to step 2442 as well. In step 2442, j is incremented by one and the procedure returns to step 2422.

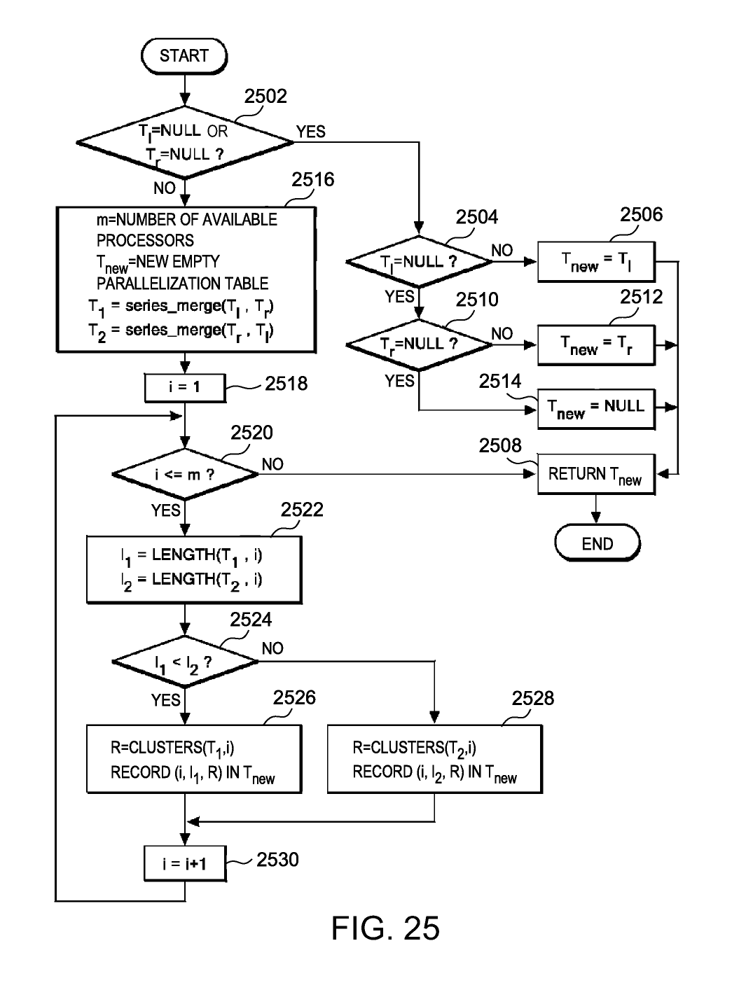

Referring next to a flowchart of FIG. 25, processing for parallel_merge (Tₗ, Tᵣ) will be described. First, in step 2502, it is determined whether T₁==NULL or Tᵣ==NULL. If so, the procedure proceeds to step 2504 in which it is determined whether T₁==NULL, while if not, T_{new}=Tₗ is set in step 2506, T_{new} is returned in step 2508, and processing is ended.

If T₁==NULL, the procedure proceeds to step 2510 in which it is determined whether Tᵣ==NULL. If not, T_{new}=Tᵣ is set in step 2512, T_{new} is returned in step 2508, and processing is ended.

If Tᵣ==NULL, the procedure proceeds to step 2514 in which T_{new}=NULL is set. Then, T_{new} is returned in step 2508, and the processing is ended.

If it is determined in step 2502 to be neither Tₗ==NULL nor Tᵣ==NULL, the procedure proceeds to step 2516 in which the number of available processors is set to m, and a new empty parallelization table is set to T_{new}.

Further, the following is set:

T₁=series_merge (T₁, Tᵣ)
T₂=series_merge (Tᵣ, T₁)
The description of series_merge is already made with reference to FIG. 24.

In step 2518, 1 is set to i, and in step 2520, it is determined whether i<=m. If it is not i<=m, the procedure goes to step 2508 to return T_{new} and end the processing.

If i<=m, the procedure proceeds to step 2522 in which l₁ and l₂ are set by the following equation:

l₁=LENGTH(T₁, i)
l₂=LENGTH(T₂, i)

In step 2524, it is determined whether l₁<l₂, and if so, R=CLUSTERS(T₁, i) is considered and (i, l₁, R) is recorded in T_{new} in step 2526.

If it is not l₁<l₂, R=CLUSTERS(T₂, i) is considered and (i, l₂, R) is recorded in T_{new} in step 2528.

Next, i is incremented by one in step 2530 and the procedure returns to step 2520.

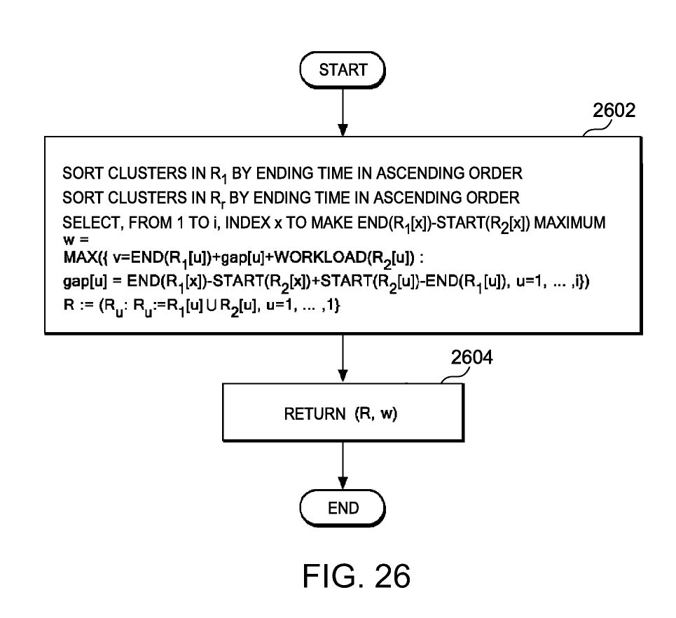

Referring next to a flowchart of FIG. 26, processing for merge_clusters_in_shared (Rₗ, Rᵣ, i) will be described.

First, in step 2602, clusters in Rₗ are sorted by ending time in ascending order.

Clusters in Rᵣ are also sorted by ending time in ascending order.

Next, index x is selected from 1 to i to make END(R₁[x])−START(R₂[x]) maximum.

Further, the following is calculated:

w=MAX({v=END(R₁[u])+gap[u]+WORKLOAD(R₂[u]):
gap[u]=END (R₁[x])−START(R₂[x])+START(R₂[u])−END(R₁[u]), u=1, . . . , i})
R:={Ru:Ru:=Rₗ[u]∪R₂[u], u=1, . . . , i}

In step 2604, (R, w) is returned, and the processing is ended.

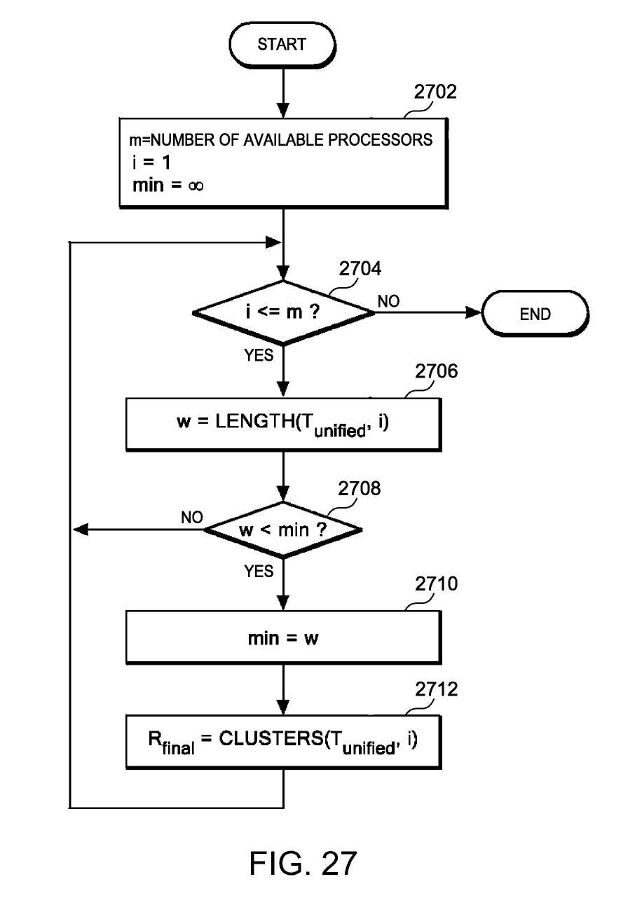

Referring next to a flowchart of FIG. 27, processing for selecting the best configuration from T_{unified} will be described. T_{unified} is obtained in step 2106 of FIG. 21. This processing is performed by the parallelization table processing module 514 in FIG. 5.

In step 2702, the number of available processors is set to m. It is also set i=1 and min=∞. Here, ∞ takes a considerably high number in actuality.

In step 2704, it is determined whether i<=m, and if so, w=LENGTH(T_{unified}, i) is calculated in step 2706, and it is determined in step 2708 whether w<min.

If it is not w<min, the procedure returns to step 2704. If w<min, min=w is set in step 2170, R_{final}=CLUSTERS(T_{unified}, i) is calculated in step 2712, and the procedure returns to step 2704.

If it is determined in step 2704 that it is not i<=m, the processing is ended. R_{final} as of then becomes the result to be obtained. FIG. 14 shows an example of the configuration selected in this manner.

Returning to FIG. 5, the compiler 520 compiles the code for each cluster based on the R_{final}, and passes it to the execution environment 522. The execution environment 522 allocates the executable code compiled for each cluster to each individual processor so that the processor will execute the code.

The methodologies of embodiments of the invention may be particularly well-suited for use in an electronic device or alternative system. Accordingly, the present invention may take the form of an entirely hardware embodiment or an embodiment combining software and hardware aspects that may all generally be referred to herein as a “processor”, “circuit,” “module” or “system.” Furthermore, the present invention may take the form of a computer program product embodied in one or more computer readable medium(s) having computer readable program code stored thereon.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While this invention has been described based on the specific embodiment, this invention is not limited to this specific embodiment. It should be understood that various configurations and techniques such as modifications and replacements, which would be readily apparent to those skilled in the art, are also applicable. For example, this invention is not limited to the architecture of a specific processor, the operating system and the like.

Further, the aforementioned embodiment is related primarily to parallelization in a simulation system for vehicle SILS, but this invention is not limited to this example. It should be understood that the invention is applicable to a wide variety of simulation systems for other physical systems such as airplanes and robots.

1. A code generating method for causing a computer having at least one processor to perform processing for generating a code allocated to each individual processor to execute the code in parallel in a multiprocessor system, the method comprising the steps of:
representing a process, to be executed, with a plurality of control blocks and edges connecting the control blocks;
identifying strongly-connected clusters of control blocks and at least one non-strongly connected cluster isolated between strongly-connected clusters;
creating a parallelization table, having entries of number of processors, costs, and corresponding clusters, for each node in each strongly-connected cluster and non-strongly connected cluster;
creating a graph comprising created parallelization tables;
converting the graph comprising the parallelization tables into a series-parallel graph;
merging the parallelization tables for each serial path; and
merging the parallelization tables for each parallel section.

2. The code generation method according to claim 1, further comprising the steps of:
selecting, as a best entry, an entry in said merged parallelization table based on the number of processors and the cost in the entries of the merged parallelization table; and
generating an executable code, to be allocated to each individual processor, based on clusters in the best entry.

3. A code generation system for causing a computer having at least one processor to perform processing for generating a code allocated to each individual processor to execute the code in parallel in a multiprocessor system, the system comprising:
an analysis module for receiving input source code and for depicting a process, to be executed, with a plurality of control blocks and edges connecting the control blocks;
a clustering module for identifying strongly-connected clusters and at least one non-strongly connected cluster isolated between strongly-connected clusters;
a parallelization table processing module for creating a parallelization table, having entries of number of processors, costs and corresponding clusters, for each node in each strongly-connected cluster and non-strongly connected cluster;
a graph module for creating a graph comprising parallelization tables;
a graph converting module for converting the graph comprising the parallelization tables into a series-parallel graph; and
a merging module for merging the parallelization tables for each serial path and for merging the parallelization tables for each parallel section.

4. The code generation system according to claim 3, further comprising:
a selection module for selecting, as a best entry, an entry, based on the number of processors and the cost in the entries of the merged parallelization table; and
a code generation module for generating an executable code, to be allocated to each individual processor, based on the clusters in the best entry.

5. A code generation program storage medium for storing a program for causing a computer having at least one processor to perform processing for generating a code allocated to each individual processor to execute the code in parallel in a multiprocessor system, the program causing the computer to execute the steps of:
identifying strongly-connected clusters and at least one non-strongly connected cluster isolated between the strongly-connected clusters;
creating a parallelization table, having entries of number of processors, costs and corresponding clusters, for each node in each strongly-connected cluster and at least one non-strongly connected cluster;
creating a graph comprising created parallelization tables;
converting the graph of the parallelization tables into a series-parallel graph; and
merging the parallelization tables for each serial path and the parallelization tables for each parallel section.

6. The code generation program according to claim 5, further comprising the steps of:
selecting, as a best entry, an entry based on the number of processors and the cost in the entries of the merged parallelization table; and
generating an executable code, to be allocated to each individual processor, based on the clusters in the best entry.
